(19) United States
(12) Patent Application Publication
(10) Pub. No.: US 2005/0259811 A1
(43) Pub. Date: Nov. 24, 2005

(54) Headset for communication devices

(76) Inventors: Daniel Kimm, San Diego, CA (US); Roy Kim, Newport Beach, CA (US); Jino Kim, Mission Hills, CA (US)

Correspondence Address: ROY KIM, P.O. BOX 4122, IRVINE, CA, 92616, US

(21) Appl. No.: 10/852,524

(22) Filed: May 24, 2004

(51) Int. Cl. H04M 1/00; H04M 9/00

(52) U.S. Cl. 379/430

(57) ABSTRACT

The present invention relates to headsets for communication devices, including, but not limited to, cell phones, smart phones, PDAs, desk top computers, and lap top computers. Specifically, this invention teaches a head set which may be fully retracted and then integrated with a communication device. For a wired head set, the microphone is located in proximity to the earpiece. A flexible sound tube extends from the microphone to the user's mouth. This flexible sound tube is pliable such that the user can bend the opening of the sound tube towards the user's mouth. In addition, the sound tube is coupled to the same wire that transmits signals between the microphone/earpiece and the communication device. The coupling of the flexible sound tube to the transmission wire allows the mouthpiece to be retracted along with the wire, up and until the microphone/earpiece. For wireless headsets, a flexible sound tube connects the user's mouth with the microphone/earpiece. This flexible sound tube is retractable so as to minimize space and thus allow the wireless headset to be directly integrated into the communication device. Should the microphone be placed near the user's mouth, a flexible, retractable arm is used to connect the microphone to the earpiece.

### BACKGROUND OF THE INVENTION

The present invention relates to headsets for communication devices, including, but not limited to, cell phones, smart phones, PDAs, desk top computers, and lap top computers. Specifically, this invention teaches a head set which may be retracted and then integrated with a communication device.

Headsets were invented in order to relieve phone user's of both fatigue and discomfort. Headsets allow the user to communicate freely without having to hold and support a phone by one's head. Despite these advantages, headsets are often not used because of certain inconveniences. For instance, traditional headsets involve wires that are often cumbersome and entangle. In order to alleviate this problem, some inventions have focused on having headsets with wires that can be retracted, much like a tape measure. These inventions retract the wires up and until the actual headset. The headset is then left to dangle outside.

Other problems are associated with wireless headsets. Since wireless headsets are not connected to the communication device they are easily misplaced or lost. And, having to carry around a separate headset-wired or wireless—in conjunction with the communication device becomes cumbersome.

The present invention seeks to further maximize the benefits associated with a headset while relieving the inconveniences. The present invention allows for full retraction of the head set. No components are left to dangle outside the retraction unit or communication device. In addition, in order to increase sound quality, a flexible mouthpiece is used to conduct sound from the user's mouth to the microphone. This flexible mouthpiece is coupled with the wire to allow for full retraction. Finally, for wireless headsets, the flexible mouthpiece is retractable so as to minimize space when fully retracted, while maximizing sound quality when fully extended. When retracted the wireless headset can then be integrated with the communication device.

### SUMMARY OF THE INVENTION

The present invention relates to an apparatus that satisfies the need for a fully retractable headset that can be integrated into either a stand-alone retraction unit or a retraction unit inside or coupled with a communication device. In a wired head set, the microphone is located in proximity to the earpiece. A flexible sound tube extends from the microphone to the user's mouth. This flexible sound tube is pliable such that the user can bend the opening of the flexible sound tube towards the user's mouth. In addition, the flexible sound tube is coupled to the same wire that transmits signals between the microphone/earpiece and the communication device. The coupling of the flexible sound tube to the transmission wire allows the mouthpiece to be retracted along with the wire, up and until the microphone/earpiece.

In another preferred embodiment, the microphone is moved away from the earpiece and placed in proximity to where the user's mouth would be located. A flexible core material then spans the length between the earpiece and microphone, thus allowing the user to bend and maintain the microphone near the user's mouth. This flexible core material is coupled with the transmission wires to allow full retraction up and until the earpiece.

For wireless headsets, a flexible sound tube connects the user's mouth with the microphone/earpiece. This flexible sound tube is retractable so as to minimize space and thus allow the wireless headset to be directly integrated into the communication device.

In yet another preferred embodiment, the microphone is moved away from the earpiece and placed in proximity to where the user's mouth would be located. The microphone and earpiece are then connected by a flexible arm which is retractable.

### BRIEF DESCRIPTION OF THE DRAWINGS

The features and advantages of this invention are better understood with regard to the following drawings, description, and claims. The drawings consist of the following:
FIG. 1 is a side view of a user employing an apparatus embodying features of this invention.
FIG. 2 is a cross-sectional view of a cell phone with an apparatus embodying features of this invention.
FIG. 3 is a front view of an apparatus embodying features of this invention.
FIG. 4 is a side view of an apparatus embodying features of this invention.
FIG. 5 is a cross-sectional view of an apparatus embodying features of this invention.
FIG. 6 is a cross-sectional view of an apparatus embodying features of this invention.
FIG. 7 is a cross-sectional view of an apparatus embodying features of this invention.
FIG. 8 is a front view of an apparatus embodying features of this invention.
FIG. 9 is a cross-sectional view of an apparatus embodying features of this invention.
FIG. 10 is a cross-sectional view of an apparatus embodying features of this invention.
FIG. 11 is a side view of an apparatus embodying features of this invention.
FIG. 12(a) is an exploded view of the hinge mechanism.
FIG. 12(b) is an exploded view of the hinge mechanism.
FIG. 12(c) is an exploded view of the hinge mechanism.
FIG. 13 is an exploded view of the hinge mechanism.
FIG. 14 is a side view of an apparatus embodying features of this invention.
FIG. 15 is a side view of an apparatus embodying features of this invention.
FIG. 16 is an exploded view of the telescoping mechanism.
FIG. 17 is a side view of an apparatus embodying features of this invention.

### DESCRIPTION OF THE INVENTION

FIG. 1 discloses the first preferred embodiment, a wired head set. The earpiece 10, adapted for the acoustical transmission of sound to the ear, is preferably like the commonly known bud ear phone. However, the earpiece 10 can be of any design and shape, known in the art. Similarly, the microphone 11 may also be of any design and shape, so long as it may be located in proximity to the earpiece 10. Preferably, the earpiece 10 and microphone 11 are coupled to each other.

Connected to the earpiece 10 and microphone 11 are their respective wires 12 which transmit signals to and from the communication device. Preferably, the respective wires 12 are coupled to each other.

To ensure maximum sounds transference between the mouth and microphone 11, a flexible sound tube 13, which is hollow, extends from the microphone 11 to the user's mouth. This flexible sound tube 13 is preferably made of a soft, pliable plastic material that is capable of maintaining its shape when bent. The user can thus bend the opening 14 of the flexible sound tube 13 towards the user's mouth. In addition, the flexible sound tube 13 is coupled to the transmission wires 12 along substantially the entire length of the sound tube 13. The coupling of the flexible sound tube 13 to the transmission wires 12 allows the flexible sound tube 13 to be retracted along with the transmission wires 12, up and until the microphone 11 and earpiece 10. See FIG. 2.

FIGS. 3 through 7 demonstrate that preferably, a flattened shaped wire is used to house the transmission wires 12 and flexible sound tube 13 so as to promote retraction without twisting and tangling.

FIG. 5 shows a cross section of the flexible sound tube 13 and transmission wires 12 at cross-section A-A as designated in FIG. 4. The transmission wires 12 are comprised of the earpiece transmission wire 12(a) and the microphone transmission wire 12(b). These transmission wires and the flexible sound tube 13 are coupled to each other along substantially the entire length of the flexible sound tube 13 so as to promote full retraction.

FIG. 6 shows a cross section at B-B below the flexible sound tube. Only the earpiece transmission wire 12(a) and microphone transmission wire 12(b) run below the sound tube.

This embodiment allows for full retraction of the headset up and until the earpiece/microphone. See FIG. 2. For example, a retraction unit, as known in the art, may be placed inside a communication device such as a cellular phone or PDA, with the headset connected to the retraction unit. When fully retracted, only the earpiece/microphone would slightly project from the communication device. The earpiece/microphone could then be pulled from the communication device to the user's ear and the flexible sound tube bent towards the user's mouth. Similarly, a stand alone retraction unit employing this headset embodiment would be able to fully retract the headset up to the earpiece/microphone.

In another preferred embodiment, the sound tube 13 is again made of a plastic material. However, in this embodiment, a flexible core 14 is coupled to the flexible sound tube 13 and the earpiece transmission wire 12(a) and the microphone transmission wire 12(b). See FIG. 7 which represents a cross-section at point A-A of FIG. 4. This flexible core 14 helps the user manipulate the shape of the flexible sound tube 13 and maintain the opening 14 of the flexible sound tube 13 by the user's mouth. In other words, in this embodiment, the flexible core 14 is responsible for maintaining the shape of the flexible sound tube 13, rather than the flexible sound tube 14 itself, as illustrated in the first preferred embodiment. The flexible core 14 is preferably made of a pliable metallic wire and is coupled to the sound tube 13 and transmission wires 12, along substantially the entire length of the sound tube 13.

FIG. 8 illustrates another preferred embodiment of the present invention. In this embodiment, the microphone 11 is moved away from the earpiece 10 and placed in proximity to where the user's mouth would be located. Since the microphone 11 is placed near the user's mouth, there is no longer the need to have the flexible sound tube. However, a flexible core 14 is coupled to the earpiece transmission wire 12(a) along substantially the entire length between the earpiece 10 and the microphone 11, thus allowing the user to bend and maintain the microphone 11 near the user's mouth.

FIG. 9 is a cross section of this preferred embodiment which better illustrate the relationship between the flexible core 14 and the earpiece transmission wire 12(a). The flexible core 14 and the earpiece transmission wire are coupled along substantially the entire length of the flexible core, from the earpiece to the microphone. FIG. 10 illustrates the relationship between the earpiece transmission wire 12(a) and the microphone transmission wire 12(b) below the flexible core 14 at cross section D-D.

For wireless head sets using technologies known in the art such as Bluetooth or an IR connection, a flexible sound tube 15 connects the user's mouth with the microphone/earpiece 16. This flexible sound tube is retractable so as to minimize space and thus allow the wireless headset to be directly coupled to the communication device.

FIG. 11 illustrates this preferred embodiment of the present invention. A flexible sound tube 15 connects the user's mouth to the microphone. It is preferably made up of a pliable plastic material which would allow the flexible sound tube 15 to be shaped such that the opening of the sound tube could be placed near the user's mouth and remain there.

The flexible sound tube 15 is further comprised of sections. By way of example, this preferred embodiment is comprised of two sections: a top half 17(a) and a bottom half 17(b). The top half and bottom half are connected by a hinge 18 which allows the flexible sound tube 15 to be folded in half. FIGS. 12(a)-12(c) illustrate the female component 18(a) and male component 18(b) of the hinge 18 as well as their interconnectivity. The female component 18(a) consists of two open hoops 19 placed opposite of each other at one end of the top half 17(a) of the flexible sound tube 15. The male component 18(b) is located on the bottom half 17(b) of the flexible sound tube 15 and has two appendages 20 which mate with the two open hoops 19. As demonstrated in FIG. 13, when fully retracted, top half 17(a) and bottom half 17(b) form the flexible sound tube 15 which allows passage of sound from the user's mouth to the earpiece/microphone 16. Although only one hinge is shown here, multiple hinges may be used to allow for further retraction.

FIGS. 14 and 15 demonstrate another preferred embodiment of the present invention whereby a telescoping mechanism is utilized to retract the flexible sound tube 15. In this embodiment, the flexible sound tube 15 is comprised of three sections: top third 21(a); middle third 21(b); and bottom third 21 (c). A telescoping mechanism is utilized whereby the smaller bottom third 21(c) is capable of sliding into the middle third 21(b) which is capable of sliding into the top third 21(a). See FIG. 15.

By way of example, FIG. 16 shows an exploded cross section of the relationship between the bottom third 21(c) and the middle third 21(b). The middle third 21(b) has indentations 22 for receiving protrusions 23 of the bottom third 21(c). When the protrusions 22 align with the indentations 23, the telescoping mechanism is fully retracted and locked into place. Retraction occurs by merely pressing up against the bottom third 21(c) and sliding it into the middle third 21(b). Although, by way of example, three sections are demonstrated here; the top third 21(a), middle third 21(b), and bottom third 21(c), the number of sections may vary.

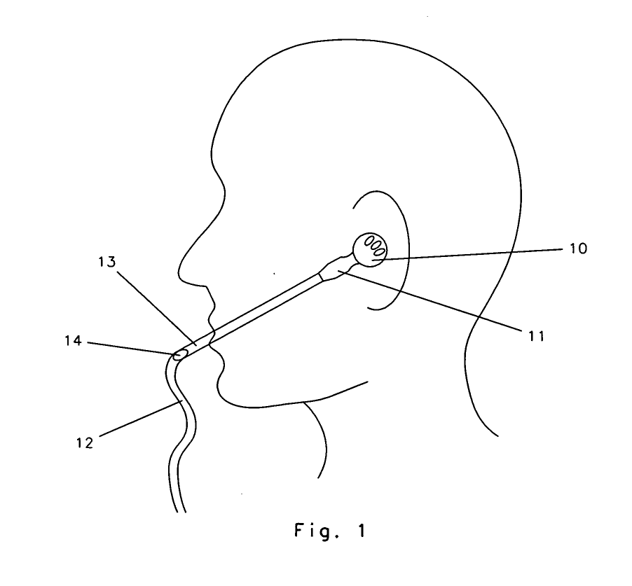

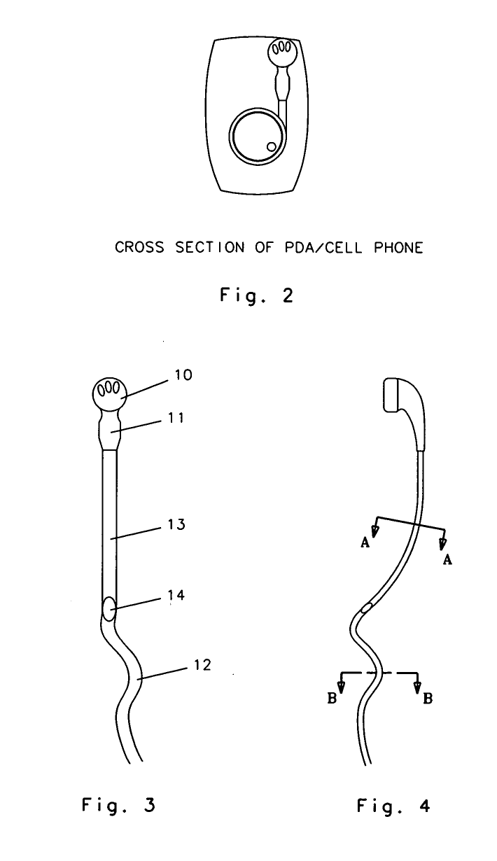

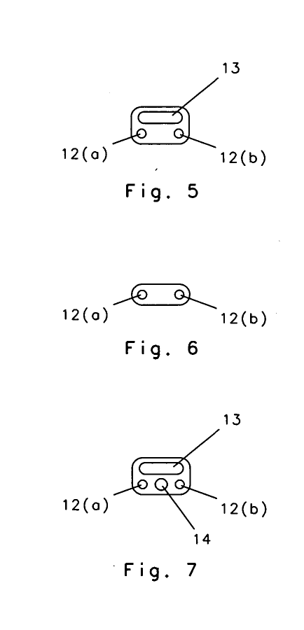

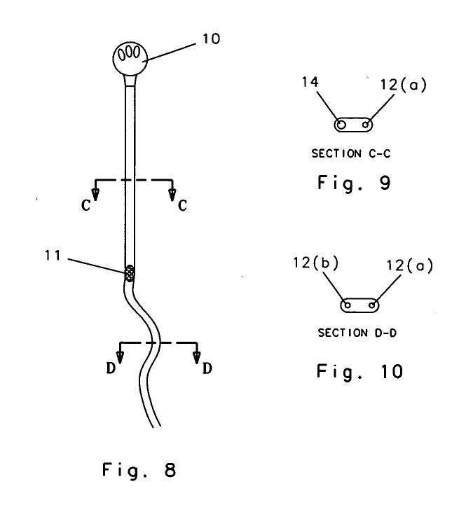

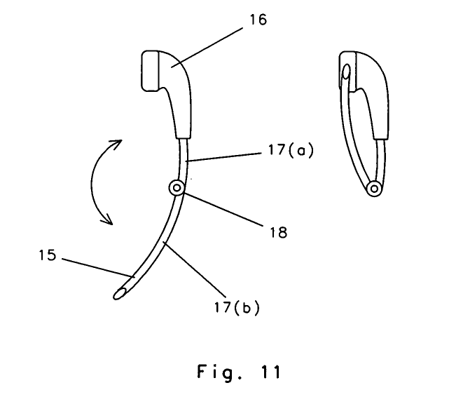

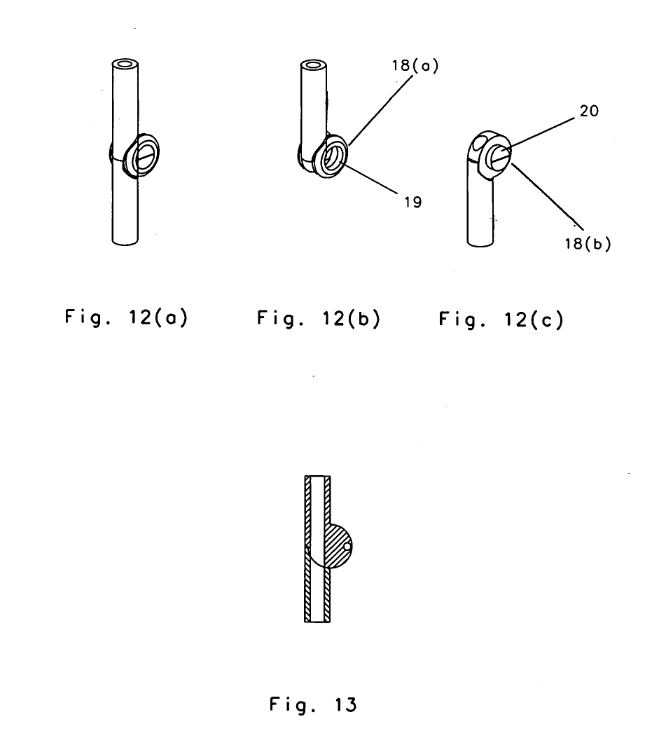

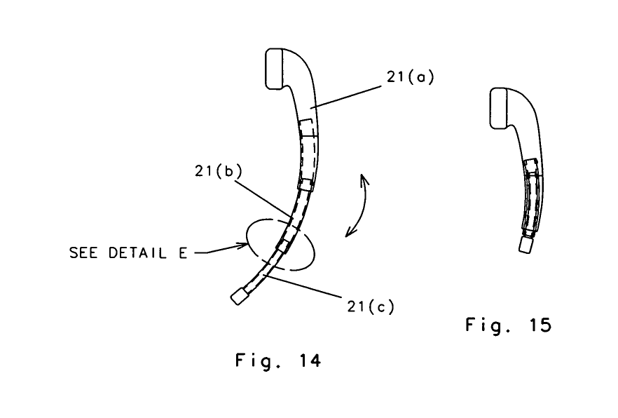

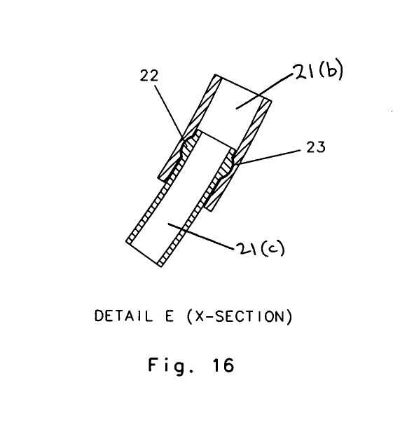

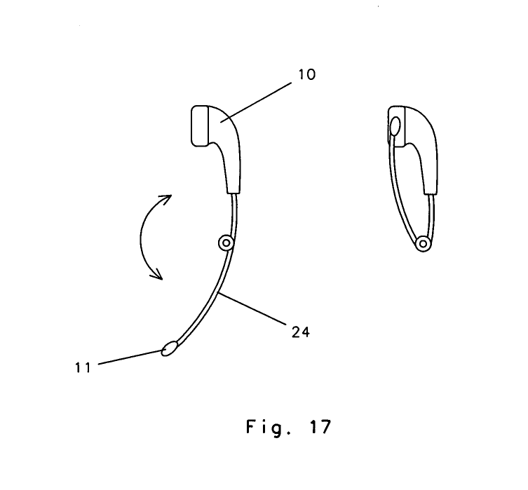

FIG. 17 illustrates yet another preferred embodiment for a wireless headset. In this embodiment, the microphone 11 is moved away from the earpiece 10 and placed in proximity to where the user's mouth would be located. In addition, since sound no longer needs to travel up to the earpiece/microphone, the hollow, flexible sound tube is no longer necessary. Instead, a retractable, flexible arm 24 is used to connect the earpiece 10 to the microphone 11. This retractable, flexible arm 24 is preferably made out of a pliable, plastic material and utilizes the same hinged or telescoping mechanism as discussed above. Thus, the microphone may be placed at the end of the bottom half of the hinge mechanism as discussed above or at the end of the bottom third of the telescoping mechanism as discussed above. The microphone 11 can then be manipulated such that it is placed in proximity to the user's mouth while in use. Afterwards, the headset can be retracted and then coupled to the communication device.

Although the present invention has been described in detail with respect to certain preferred versions thereof, other versions are possible. Therefore, the scope of the claims should not be limited to the description of the preferred versions contained herein.

1. A headset comprised of:
(a) an earpiece;
(b) a microphone coupled to the earpiece;
(c) transmission wires connected to the earpiece and microphone;
(d) a flexible sound tube extending from the microphone;
(e) said flexible sound tube coupled to the transmission wires along substantially the entire length of said flexible sound tube.

2. The headset of claim 1 wherein the flexible sound tube is made of a pliable plastic material.

3. The headset of claim 1 or 2, wherein a flattened shaped wire is used to house the transmission wires and flexible sound tube.

4. The headset of claim 1 or 2 wherein a flexible core is coupled to said sound tube and said transmission wires along substantially the entire length of said sound tube.

5. The headset of claim 4, wherein a flattened shaped wire is used to house the transmission wires, sound tube, and flexible core.

6. The headset of claim 4 wherein the flexible core is made of a pliable metallic wire.

7. A headset comprised of:
a. an earpiece;
b. an earpiece transmission wire connected to the earpiece;
c. a microphone capable of being placed in proximity to where a user's mouth would be;
d. a microphone transmission wire connected to the microphone;
e. a flexible core coupled to the earpiece transmission wire along substantially the entire length between the earpiece and the microphone.

8. The headset of claim 7 wherein the flexible core is made of a pliable metallic wire.

9. A wireless headset comprised of:
a. an earpiece;
b. a microphone coupled to the earpiece;
c. a retractable, flexible sound tube extending from the microphone;

10. The wireless headset of claim 9, wherein said retractable, flexible sound tube is comprised of sections connected by at least one hinge.

11. The wireless headset of claim 9 wherein said retractable, flexible sound tube is comprised of sections connected by a telescoping mechanism.

12. The wireless headset of claim 10 or 11, wherein said retractable, flexible sound tube is made up of a pliable plastic material.

13. A wireless headset comprised of:
a. an earpiece;
b. a microphone capable of being placed in proximity to where a user's mouth would be;
c. a retractable, flexible arm which connect the earpiece to the microphone.

14. The wireless headset of claim 13, wherein said retractable, flexible arm is comprised of sections connected by at least one hinge.

15. The wireless headset of claim 13 wherein said retractable, flexible arm is comprised of sections connected by a telescoping mechanism.

16. The wireless headset of claim 14 or 15, wherein said retractable, flexible arm is made up of a pliable plastic material.
